(19) United States
(12) Patent Application Publication
(10) Pub. No.: US 2008/0179789 A1
(43) Pub. Date: Jul. 31, 2008

(54) Apparatus and Methods for Providing Airflow Within an Aircraft Using Clamshell Components

(75) Inventors: W. Forrest Frantz, North Bend, WA (US); Douglas D. Maben, Snohomish, WA (US); Bryan Bergsma, Tucson, AZ (US); Danny Jorgenson, Spokane, WA (US)

Correspondence Address: LEE & HAYES, PLLC, 421 W. RIVERSIDE AVE., SUITE 500, SPOKANE, WA, 99201, US

(73) Assignee: THE BOEING COMPANY, Chicago, IL (US)

(21) Appl. No.: 12/057,334

(22) Filed: Mar. 27, 2008

Related U.S. Application Data
(62) Division of application No. 10/876,068, filed on Jun. 24, 2004, now abandoned.

(51) Int. Cl. B29C 43/14

(52) U.S. Cl. 264/320

(57) ABSTRACT

Apparatus and methods for providing airflow within an aircraft are disclosed. In one embodiment, a method includes forming a clamshell component, including: providing first and second spaced-apart mold members; forming first and second half-body portions, including forming at least one sheet of formable material between the first and second mold members; and coupling the first and second half-body portions to form the clamshell component. The method also includes coupling the clamshell component to a source of air; and operating the source of air to provide an airflow through the clamshell component.

### CROSS REFERENCE TO RELATED APPLICATIONS

This patent application is a divisional application of co-pending, commonly-owned U.S. patent application Ser. No. 10/876,068 entitled “Apparatus and Methods for Forming Thermoplastic Clamshell Components” filed on Jun. 24, 2004, which application is incorporated herein by reference.

### FIELD OF THE DISCLOSURE

This disclosure relates generally to apparatus and methods for providing airflow within an aircraft using clamshell components, including, for example, curved ducts and other structures having complex curvature.

### BACKGROUND OF THE DISCLOSURE

Methods of forming ducts and other components having complex curvature typically require the formation of a mold (or mandrel) and then a hand-layup of prepreg material onto the mold. The mold may be formed out of plaster or other suitable materials. The prepreg material is then cured, and the component is removed from the mold. Sometimes, the mold is destroyed during the removal process, necessitating the formation of another mold in order to create another component.

Although desirable results have been achieved using such prior art apparatus and methods, there is room for improvement. Whereas the formation of straight ducts and other relatively simple components may be straightforward and relatively economical, the formation of components having unusual or complex curvature may be very expensive using the prior art apparatus and methods. Because many components of an aircraft involve relatively complex curvatures, the increased costs due to the formation of such components can significantly impact the cost of production of the aircraft. Therefore, novel apparatus and methods that at least partially mitigate the costs associated with forming components having complex curvature would be useful and desirable.

### SUMMARY

The present disclosure is directed to apparatus and methods for providing airflow within an aircraft using clamshell components, including, for example, curved ducts and other structures having complex curvature. Embodiments of apparatus and methods in accordance with the present disclosure may advantageously reduce the time and expense associated with forming components having unusual or complex curvature in comparison with the prior art.

In one embodiment, a method of providing an airflow within an aircraft includes forming a clamshell component, including: providing first and second spaced-apart mold members; forming first and second half-body portions, including forming at least one sheet of formable material between the first and second mold members; and coupling the first and second half-body portions to form the clamshell component. The method also includes coupling the clamshell component to a source of air; and operating the source of air to provide an airflow through the clamshell component.

The features, functions, and advantages that have been described above or will be discussed below can be achieved independently in various embodiments, or may be combined in yet other embodiments, further details of which can be seen with reference to the following description and drawings.

### BRIEF DESCRIPTION OF THE DRAWINGS

Embodiments of the present disclosure are described in detail below with reference to the following drawings.

FIG. 1 is a schematic side elevational view of a system for forming thermoplastic clamshell components in accordance with an embodiment of the present disclosure.

FIG. 2 is an isometric view of a first mold member of the system of FIG. 1.

FIG. 3 is an isometric view of a second mold member of the system of FIG. 1.

FIG. 4 is a top elevational view of a portion of a component formed using the system of FIG. 1 in accordance with an embodiment of the disclosure.

FIG. 5 is an isometric view of a component formed in accordance with the disclosure integrated into an air distribution system in accordance with another embodiment of the disclosure.

FIG. 6 is an isometric view of a pair of component portions formed in accordance with an alternate embodiment of the present disclosure.

FIG. 7 is an isometric view of a component formed from the component portions of FIG. 6.

FIG. 8 is a partially-exploded, isometric view of a pair of component portions formed in accordance with another embodiment of the present disclosure.

FIG. 9 is an isometric view of the first and second portions of FIG. 8 being coupled together in accordance with another embodiment of the present disclosure.

FIG. 10 is an isometric view of an apparatus for bonding a pair of components together in accordance with the disclosure.

FIG. 11 is an enlarged, partial isometric view of the bonding apparatus of FIG. 10.

FIGS. 12 through 15 are isometric views of a pair of components being coupled together in accordance with further embodiments of the present disclosure.

### DETAILED DESCRIPTION

The present disclosure relates to apparatus and methods for forming thermoplastic clamshell components. Many specific details of certain embodiments of the disclosure are set forth in the following description and in FIGS. 1-15 to provide a thorough understanding of such embodiments. One skilled in the art, however, will understand that the present disclosure may have additional embodiments, or that the present disclosure may be practiced without several of the details described in the following description.

Generally speaking, apparatus and methods for forming thermoplastic clamshell components in accordance with the present disclosure may include positioning a sheet of thermoplastic material between a pair of mold members, forming the thermoplastic material between the mold members to form a half-body component, and then joining two or more half-body components together to form a thermoplastic clamshell component. As used in the following description, the term “clamshell” generally refers to a process that uses tools to press form two or more segments of a part, and then joining those segments together in a manner that creates a whole functioning part. There are at least two approaches used to accomplish such processes. In a first approach, the two half-body segments may be press-formed in a press or other suitable device, and then joined together in a subsequent step outside the press. Alternately, the half-body segments may be press-formed in a press, and may also be joined together in the press, either simultaneously or subsequently with the press-forming of the half-body segments. In the following discussion, unless otherwise specified, the various apparatus and methods in accordance with the present disclosure described below are applicable to both of these alternate approaches.

FIG. 1 is a schematic, side elevational view of a system 100 for forming thermoplastic clamshell components in accordance with an embodiment of the present disclosure. In this embodiment, the system 100 includes a first mold member 102, and a second mold member 104 position above the first mold member 102. A thermoplastic sheet 106 is positioned between the first and second mold members 102, 104. An actuator 108 is coupled to the second mold member 104 and is adapted to controllably move the second mold member 104 into engagement with the thermoplastic sheet 106, forming the thermoplastic sheet 106 between the first and second mold members 102, 104.

The thermoplastic sheet 106 may be, for example, an Ultem® sheet, or a Reinforced Thermoplastic Laminate (RTL) sheet, or any other suitable thermoplastic material. More specifically, the thermoplastic sheet 106 may be an RTL sheet using a polyeitherimide (PEI or Ultem) matrix with either an Aramid (Kevlar), carbon, glass fibers, or any combination thereof, in a thermoplastic sheet. In general, in presently preferred embodiments, the glass transition point of the thermoplastic (where the material begins to flow) should be greater than the upper thermal requirement of the application. The creep forming point of the thermoplastic (where the material begins to change shape with low forces over time) should be greater than the upper thermal requirement. For example, for ECS ducts in aircraft, the upper thermal requirement is approximately 185 degrees F. The thermoplastic should also have the chemical resistance to products used in the application. For example, ECS ducts in aircraft use pesticides or cleaners that can attack certain types of plastics.

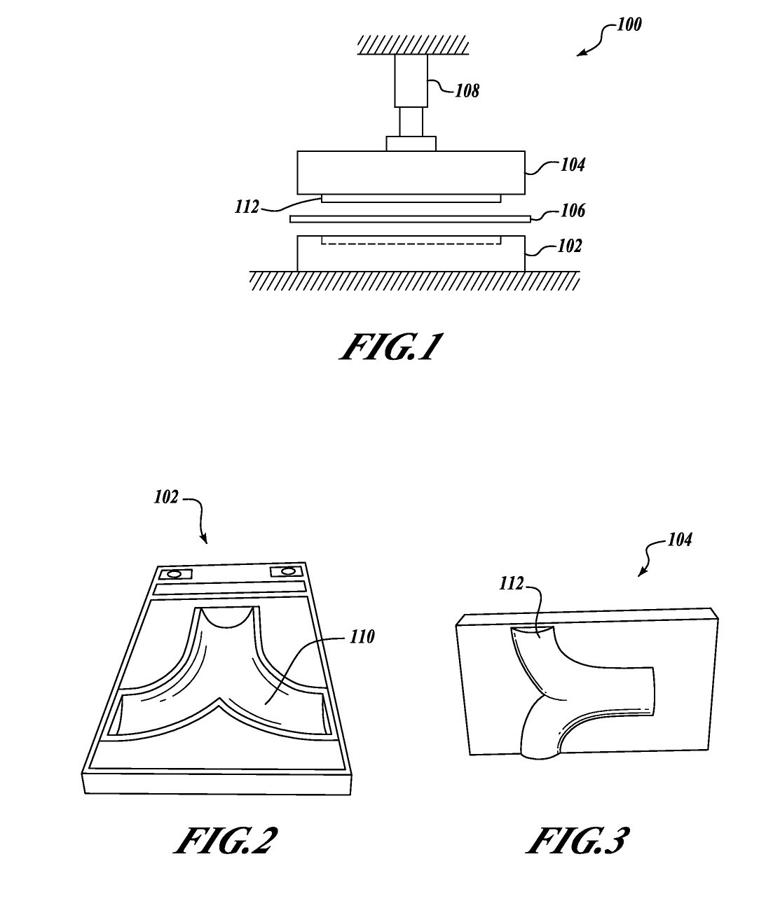

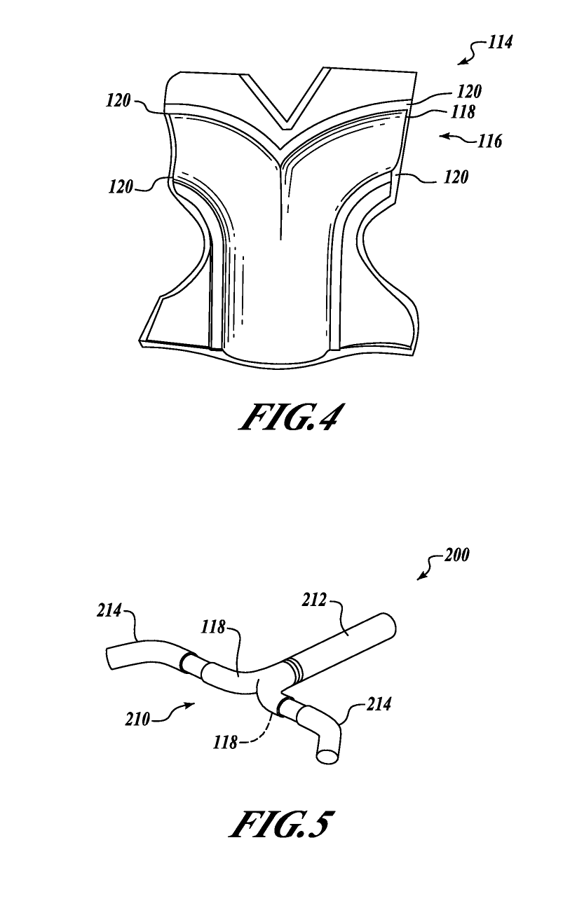

FIG. 2 is an isometric view of the first mold member 102 of the system 100 of FIG. 1. In this embodiment, the first mold member 102 includes a recessed portion 110. Similarly, FIG. 3 is an isometric view of the second mold member 104 of the system 100 of FIG. 1. The second mold member 104 has a protruding portion 112 that is adapted to engage with the recessed portion 110 of the first mold member 102 leaving room for the thermoplastic sheet 106 to be formed between mold members 102 and 104.

In operation, the thermoplastic sheet 106 is positioned between the first and second mold members 102, 104. The actuator 108 is then employed to drive the second mold member 104 against the thermoplastic sheet 106, forming the thermoplastic sheet 106 between the first and second mold members 102, 104. The thermoplastic sheet 106 is then press formed into a first-stage workpiece 114. FIG. 4 is a top elevational view of the first-stage workpiece 114 formed using the system 100 of FIG. 1. The first-stage workpiece 114 may then be trimmed, forming a second-stage workpiece 116 that includes a “Y”-shaped half-body portion 118 and one or more flange portions 120.

FIG. 5 is an isometric view of an air distribution system 200 including a component 210 formed in accordance with another embodiment of the present disclosure. In this embodiment, the component 210 includes a pair of “Y”-shaped half-body portions 118 formed in accordance with the present disclosure as described above with reference to FIGS. 1-4. The “Y”-shaped half-body portions 118 that might be the same, opposite, or unique beyond the common bond flange, are bonded together in any suitable manner to form the component 210, as described more fully below. In addition, the component 210 is coupled a cylindrical supply tube 212 and to a pair of elbow tubes 214. The air distribution system 200 may be used in a wide variety of applications, including for example, in a fresh-air distribution system of a commercial aircraft.

Embodiments of apparatus and methods in accordance with the present disclosure may provide significant advantages over the prior art. Because components having unusual or complex curvature may be formed by press-molding a sheet of thermoplastic material between first and second mold members to form first and second half-body portions, and then coupling the first and second half-body portions together to form the desired component, the need to create relatively complex plaster mandrels and to perform labor-intensive layup processes is reduced or eliminated. Thus, the time and expense associated with forming components having unusual or complex curvature may be reduced in comparison with the prior art methods. Similarly, the cost of fabricating structures that include such complex components, such as aircraft, can also be reduced.

It will be appreciated that the disclosure is not limited to the particular embodiments described above and shown in FIGS. 1-5, and that a variety of alternate embodiments may be conceived without departing from the spirit and scope of the disclosure. For example, the actuator 108 may be coupled to the second mold a member 104 rather than the first mold member 102, or additional actuators may be added, or the actuator may even be eliminated and the process performed manually. Further, the recessed portion 110 and a protruding portion 112 may have a variety of different shapes adapted to form a variety of different thermoplastic components, and are not limited to the particular embodiments described above and shown in the accompanying figures. Thus, embodiments of the present disclosure include one or more components formed by press-forming thermoplastic material between two or more tools that define the pre-join shape of the component to other components that may have the same shape, opposite shape, or totally unique shape that has a common and opposite shaped flange.

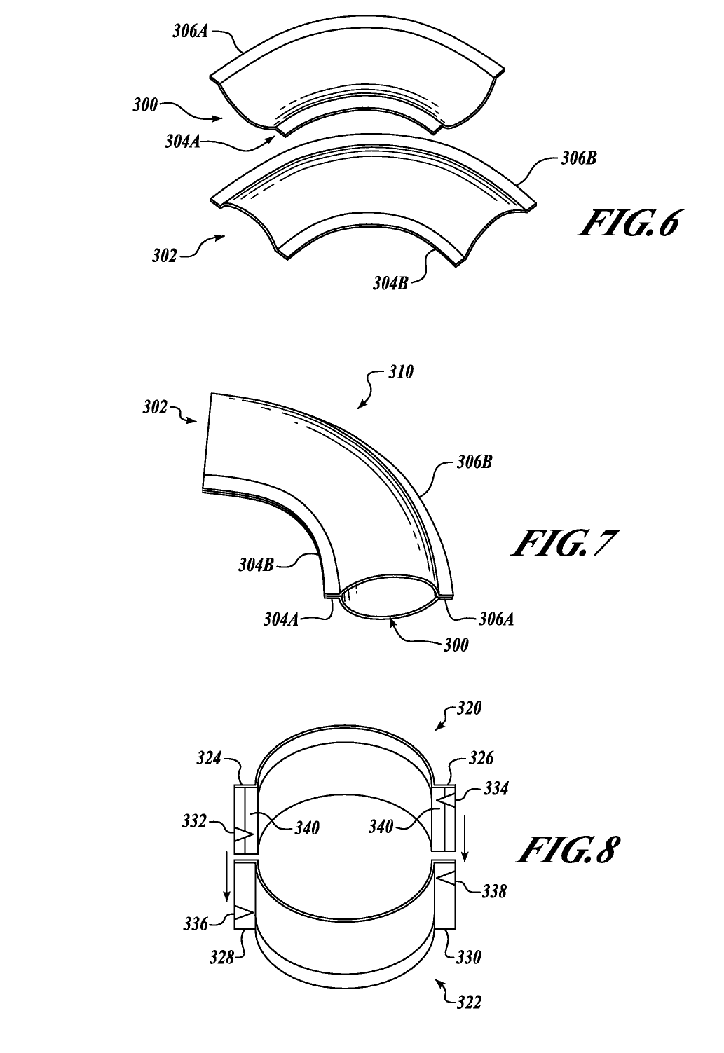

For example, FIG. 6 is an isometric view of a pair of component portions 300, 302 formed in accordance with an alternate embodiment of the present disclosure. In this embodiment, the component portions 300, 302 are identical elbow-shaped half-body portions that may be coupled together to form an elbow-shaped duct 310 (FIG. 7). Each of the component portions 300, 302 includes an inner flange portion 304 and an outer flange portion 306. The inner flange portions 304A, 304B may be bonded together, and the outer flange portions 306A, 306B may be bonded together, thereby forming the elbow-shaped duct 310.

There are a number of ways in which the flange portions of the half-body portions of the clamshell can be made. For example, the flange can be perpendicular to the duct body, angled to the duct body or made to overlap within the duct body. Of course, other alternatives also exist.

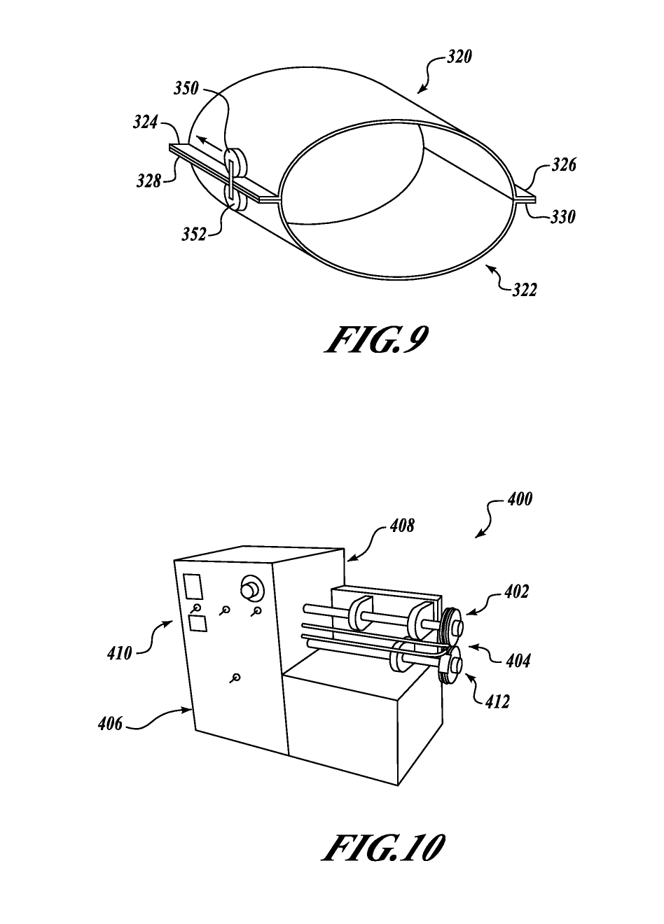

There are also a number of ways in which the flange portions of the half-body portions of a clamshell component may be coupled together in accordance with various alternate embodiments of the present disclosure. For example, FIG. 8 is a partially-exploded, isometric view of a pair of component portions 320, 322 formed in accordance with another embodiment of the present disclosure. In this embodiment, the first portion 320 includes first and second flanges 324, 326. The first flange 324 includes a first index member 332, and the second flange 326 includes a first index recess 334. Similarly, the second portion 322 includes a third flange 328 having a second index recess 336, and a fourth flange 330 having a second index member 338. An adhesive strip 340 is disposed on each of the first and second flanges 324, 326. In operation, the first and second portions 320, 322 may be positioned with the first and third flanges 324, 328 positioned proximate to each other and the second and fourth flanges 326, 330 positioned proximate to each other. As the flanges are brought into contact, the first index member 332 is engaged into the second index recess 336, and the second index member 338 is engaged into the first index recess 334. In this way, the index members 332, 338 and the index recesses 334, 336 ensure that the first and second portions 320, 322 are properly positioned for bonding. The adhesive strips 340 secure the first and second portions 320, 322 together to form the resulting clamshell component. In one embodiment, the adhesive strip includes a composite grade adhesive.

In an alternate embodiment, the flanges of the first and second portions 320, 322 may be bonded by a combination of heat and pressure. For example, FIG. 9 is an isometric view of the first and second portions 320, 322 of FIG. 8 being coupled together in accordance with another embodiment of the present disclosure. In this embodiment, a pair of heated cams 350, 352 are engaged against the first and third flanges 324, 328, respectively. In operation, the flanges 324, 328 are pinched between the heated cams 350, 352 as the cams are translated along the length of the flanges 324, 328. A similar bonding process can be performed on the second and fourth flanges 326, 330.

During the translation of the heated cams 350, 352 along the flanges, the heated cams 350, 352 elevate the flanges above a glass transition temperature of the thermoplastic materials of the flange, thereby allowing the flanges to consolidate and bond. Following the heating, pressure may be maintained on the heated portion of the flanges by a follower mechanism (e.g. shoes, wheels, etc.) until the temperature of the joint is below the glass transition temperature. The heated cams 350, 352 may be used in conjunction with an adhesive material (FIG. 8), such as an adhesive thermoplastic tape, to increase the amount of matrix material in the bond area. The headed cams and follower mechanism can be flat or have a shape that helps change the shape and thus the shear characteristics of the flange. For example, a hump, ridge, or more radical shapes such as a crimp can be employed, as described more fully below.

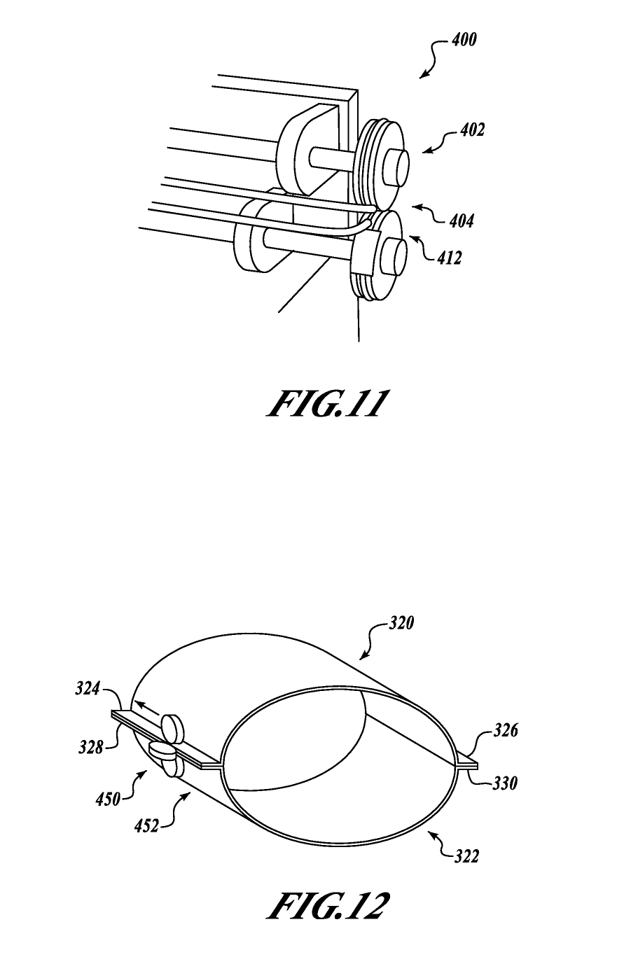

FIG. 10 is an isometric view of a bonding apparatus 400 for bonding a pair of thermoplastic clamshell components together in accordance with another embodiment of the disclosure. FIG. 11 is an enlarged, partial isometric view of the bonding apparatus 400 of FIG. 10. In this embodiment, the bonding apparatus 400 includes first and second heated cams 402, 404. The heated cams 402, 404 are operatively coupled to a drive motor 406 and to a heat source 408. A control panel 410 is coupled to the drive motor 406 and the heat source 408. The control panel 410 enables an operator (not shown) to control the temperature, pressure, and drive speed of the heated cams 402, 404. As best shown in FIG. 11, a preheater 412 is positioned proximate the cams 402, 404. In operation, the preheater 412 engages against the flanges as they are being fed into the heated cams. The preheater 412 preheats the flanges prior to being fully heated and pinched by the heated cams 402, 404, thereby improving the quality of the bond.

FIG. 12 is an isometric view of the first and second components 320, 322 being coupled together in accordance with a further embodiment of the present disclosure. In this embodiment, a crimping tool 450 is translated along the flanges 324, 328, bending or crimping the flanges into a crimped portion 452. In the embodiment shown in FIG. 12, the crimped portion 452 is an approximately right-angled portion, however, in alternate embodiments, other cross-sectional shapes of crimped portions may be used. More specifically, the crimp can be just over 0 degrees (obtuse fold) and approach 180 degrees (acute fold). The crimping tool 450 is similar to the heated cams described above, and can apply heat and pressure as described above, except that the crimping tool 450 also puts a crimp in the flanges. This is done to increase the seam strength of the joint, thereby providing a suitable bond that couples the first and second components 320, 322 together.

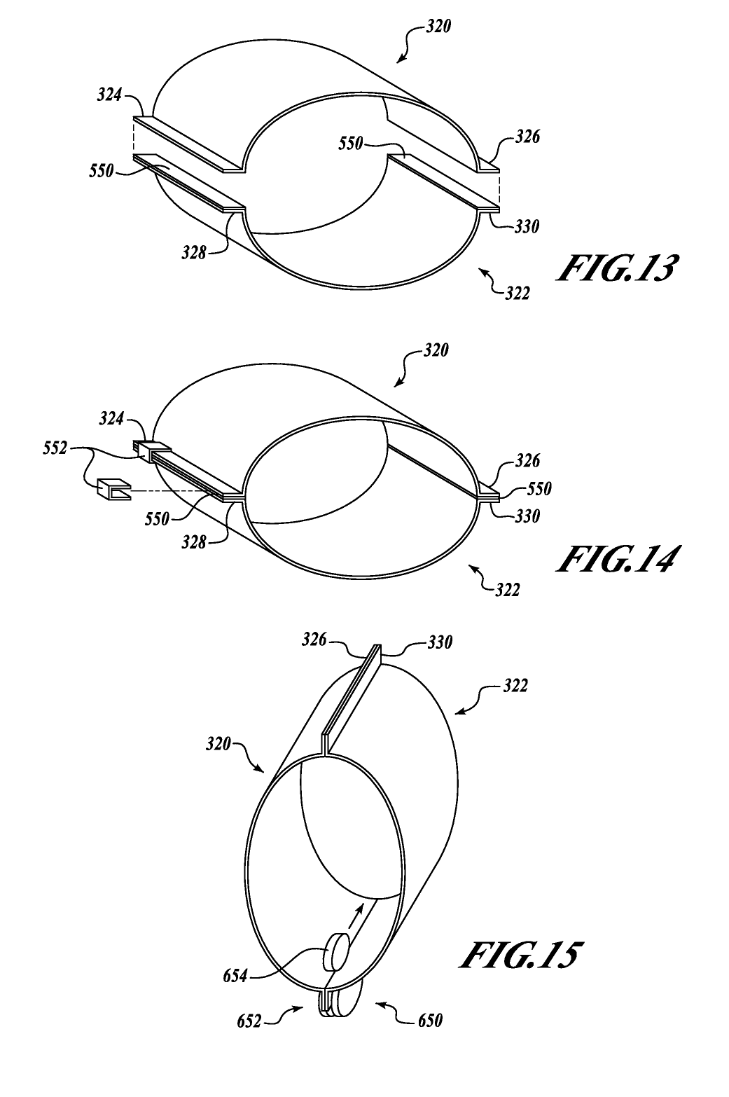

FIG. 13 is a partially exploded isometric view of the first and second components 320, 322 being coupled together in accordance with a further embodiment of the present disclosure. FIG. 14 is an isometric view of the first and second components 320, 322 of FIG. 13 in a coupled position. In this embodiment, a sealant (or adhesive) material 550 is disposed between the flanges. As noted above, in one particular embodiment, the sealant is a composite grade adhesive. The sealant can be brushed on, applied from a tube or other container, applied in roll form, or may be applied using any other suitable application method. The sealant can be room or oven cured. As further shown in FIG. 14, one or more clips 552 may be used to lock the first and second components 320, 322 together. In alternate embodiments, other fastening devices may be used instead of or in addition to the clips 552, including, for example, rivets or other types of fasteners.

FIG. 15 is an isometric view of the first and second components 320, 322 of FIG. 13 in a coupled position in accordance with yet another embodiment of the disclosure. In this embodiment, a welding device 650 is applied to the flanges. The welding device 650 includes a pair of external rollers 652 applied along opposing sides of the flanges, and an internal roller 654. The welding device 650 is translated along the flanges, applying elevated temperature and pressure to the flanges, forming a weld bond. More specifically, the welding device 650 adds material to the joint by liquefying a primary material matrix of the thermoplastic material (e.g., Ultem/PEI, PPS, Nylon or other thermoplastic matrix) into the joint which is also heated so the added material becomes one with the joint, just as a metallic weld is formed when metal is added to a seam of the metallic weld. In one particular embodiment, the materials can be added in a tape form and then melted into the seam, or alternately, it can be melted in a gun and extruded into the seam. The material can also be applied perpendicular to the joint or between the flanges and joined using the same tools used to crimp or consolidate as described above.

While preferred and alternate embodiments of the disclosure have been illustrated and described, as noted above, many changes can be made without departing from the spirit and scope of the disclosure. Accordingly, the scope of the disclosure is not limited by the disclosure of the preferred and alternate embodiments. Instead, the disclosure should be determined entirely by reference to the claims that follow.

What is claimed is:

1. A method of providing airflow within an aircraft, comprising:
forming a clamshell component, including:
providing a first mold member;
providing a second mold member proximate the first mold member and configured to engage with the first mold member;
providing a first sheet of formable material disposed between the first and second mold members;
forming the first sheet of formable material between the first and second mold members to form a first component portion;
disengaging the first and second mold members from the first sheet of formable material;
providing a second sheet of formable material disposed between the first and second mold members;
forming the second sheet of formable material between the first and second mold members to form a second component portion;
disengaging the first and second mold members from the second sheet of formable material; and
coupling the first and second component portions;
coupling the clamshell component to a source of air; and
operating the source of air to provide an airflow through the clamshell component.

2. The method of claim 1, wherein providing a first sheet of formable material includes providing a sheet of thermoplastic material.

3. The method of claim 2, wherein providing a sheet of thermoplastic material includes providing a sheet of a reinforced thermoplastic material.

4. The method of claim 1, wherein providing a first sheet of formable material includes providing a sheet having at least one of an Ultem matrix material, a polyeitherimide matrix material, an Aramid fiber, a Kevlar fiber, a carbon fiber, and a glass fiber.

5. The method of claim 1, wherein coupling the first and second component portions includes engaging a first index member formed on a flange portion of the first component portion with a first recess formed in a corresponding flange portion of the second component portion.

6. The method of claim 1, wherein coupling the first and second component portions includes bonding a flange portion of the first component portion with a corresponding flange portion of the second component portion with an adhesive material.

7. The method of claim 1, wherein coupling the first and second component portions includes joining a flange portion of the first component portion together with a corresponding flange portion of the second component portion between a pair of heated members.

8. The method of claim 7, wherein joining the flange portions between the pair of heated members includes elevating a temperature of the flange portions above a glass transition temperature of the flange portion.

9. The method of claim 7, further comprising preheating the flange portions prior to forming the flange portions between the pair of heated members.

10. The method of claim 7, further comprising maintaining a pressure on the flange portions after forming the flange portions between the pair of heated members.

11. The method of claim 1, wherein coupling the first and second component portions includes crimping a flange portion of the first component portion together with a corresponding flange portion of the second component portion.

12. The method of claim 11, wherein crimping the flange portions includes forming an approximately right-angled bend in the flange portions.

13. The method of claim 1, wherein coupling the first and second component portions includes welding a flange portion of the first component portion together with a corresponding flange portion of the second component portion.

14. The method of claim 13, wherein welding the flange portions includes adding a liquefied matrix material between the first and second flange portions.

15. A method of providing airflow within an aircraft, comprising:
forming a clamshell component, including
providing first and second spaced-apart mold members;
forming first and second half-body portions, including forming at least one sheet of formable material between the first and second mold members;
coupling the first and second half-body portions to form the clamshell component; and
coupling the clamshell component to a source of air.

16. The method of claim 15, wherein coupling the first and second half-body portions to form the clamshell component includes engaging a first index member formed on a flange portion of the first half-body portion with a first recess formed in a corresponding flange portion of the second half-body portion.

17. The method of claim 15, wherein coupling the first and second half-body portions to form the clamshell component includes bonding a flange portion of the first half-body portion with a corresponding flange portion of the second half-body portion with an adhesive material.

18. The method of claim 15, wherein coupling the first and second half-body portions to form the clamshell component includes forming a flange portion of the first half-body portion together with a corresponding flange portion of the second half-body portion between a pair of heated members.

19. The method of claim 15, wherein coupling the first and second half-body portions to form the clamshell component includes crimping a flange portion of the first half-body portion together with a corresponding flange portion of the second half-body portion.

20. The method of claim 19, wherein crimping the flange portions includes forming an approximately right-angled bend in the flange portions.

21. The method of claim 15, wherein coupling the first and second half-body portions to form the clamshell component includes welding a flange portion of the first half-body portion together with a corresponding flange portion of the second half-body portion.
